(19) United States
(12) Patent Application Publication
(10) Pub. No.: US 2012/0088306 A1
(43) Pub. Date: Apr. 12, 2012

(54) Method Of Assaying Noble Metals

(75) Inventors: Walter Grasser, Osthofen (DE); Andreas Groß, Speyer (DE); Hans Päbst, Ludwigshafen (DE); Imme Domke, Mannheim (DE); Alexej Michailovski, Ludwigshafen (DE)

(73) Assignee: BASF SE, Ludwigshafen (DE)

(21) Appl. No.: 13/269,120

(22) Filed: Oct. 7, 2011

Related U.S. Application Data
(60) Provisional application No. 61/391,103, filed on Oct. 8, 2010.

(51) Int. Cl. G01N 27/72

(52) U.S. Cl. 436/73

(57) ABSTRACT

Provided is a method of assaying noble metals in a mineral and/or ceramic matrix in the content range from 0.03 to 500 mg/kg. The method comprises dry thermal treatment of a homogenized sample in a reducing atmosphere, extraction in an oxidizing medium, and atomic spectrometric quantification of the noble metals by means of ICP-QMS.

### CROSS-REFERENCE TO RELATED APPLICATIONS

This application claims priority under 35 U.S.C. §119(e) to U.S. Provisional Application No. 61/391,103, filed on Oct. 8, 2010, which is incorporated herein by reference in its entirety.

### BACKGROUND

Noble metals play an important role in our society. They are used for industrial purposes, e.g. in catalysts, or worked for jewelry purposes.

In nature, noble metals predominantly occur associated with rocks, with the contents usually being very small. For example, platinum occurs in the rocks dunite, peridotite and serpentinite. Palladium occurs in the form of heavy metal sulfides such as sperrylite, arsenopalladinite, cooperite and stibiopalladinite.

They are recovered by means of flotation processes or leaching methods. In these work-up steps, the noble metals (or the minerals containing the noble metal) are firstly concentrated (from 0.1 ppm to 30-500 ppm).

The assaying of noble metals in rock samples or the matrices obtained during the work-up is therefore an essential prerequisite in order to be able to assess whether a work-up is economically feasible or what type of subsequent further concentration and processing steps (smelting process, refining) are required. The matrices may be for example concentrates, tailings, slag or filters. This assay has classically been carried out by fire assay. Nowadays, the term fire assay refers generally to the analysis of noble metal-comprising raw materials in which the samples of noble metal-comprising ores are dry-chemically fused with a complex mixture of decomposition agents and fluxes.

The decomposition agent usually comprises lead. In this form of fire assay, a lead button in which the noble metals of the sample are in the ideal case completely dissolved is formed and is separated manually from the slag. Since the noble metals ideally collect completely in the lead button, this is also referred to as collector. Further collectors employed are nickel or nickel sulfides.

In the simplest case, the noble metal content is determined gravimetrically after vaporization of the lead (cupellation).

It is also possible to dissolve the collector and to determine the noble metals by means of (atomic) spectrometric methods. This is described, for example, in Date, A. R., Davis, A. E. and Cheung, Y. Y., 1987. The potential of fire assay and inductively coupled plasma source mass spectrometry for the determination of platinum group elements in geological materials. Analyst 112, 1217-1222.

Other methods comprise examining the lead button directly by means of various spectroscopic and spectrometric analytical methods. These can be solid-sampling-graphite furnace-atomic absorption spectrometry (SS-GF-AAS); solid-sampling-electrothermal vaporization-inductively coupled plasma-mass spectrometry (SS-ETV-ICP-MS); laser ablation-inductively coupled plasma-mass spectrometry (LA-ICP-MS); spark-optical emission spectrometry (spark-OES); and glow discharge-mass spectrometry (GD-MS) (M. Resano, E. Garcia-Ruiz, M. A. Bellara; F. Vanhaecke, K. S. MacIntosh, Trends in Analytical Chemistry, Vol. 26, No. 5, 2007, pages 385-395). As a variant of dry-chemical, an alternative trace matrix separation, e.g. by means of a tellurium precipitation, after fusion of the samples and subsequent dissolution has been described (J. G. Gupta; Talanta 36 (1989), 651-656).

Zhiqiang Li, Zhanbo Li, Determination of micro-content gold in geochemical exploration sample by inductively coupled plasma mass spectrometry (ICP-MS) Xibu Tankuang Gongcheng (2010), 22(6), 116-117, describe the extraction of gold from rock samples by means of aqua regia. This is followed by a trace matrix separation in which the dissolved gold is adsorbed on a foam which is ashed. The gold is subsequently redissolved in aqua regia and analyzed by means of ICP-MS.

Charles Gowing, Philip Potts, Evaluation of a rapid technique for the determination of precious metals in geological samples based on a selective aqua regia leach, Analyst (Cambridge, United Kingdom) (1991), 116(8), 773-779, describe the extraction of noble metals from rock samples. Gold and to some extent also palladium can be determined quantitatively, but the remaining platinum group metals cannot.

In G. E. M. Hall, C. J. Oates, Performance of commercial laboratories in analysis of geochemical samples for gold and the platinum group elements, Geochemistry: Exploration, Environment, Analysis (2003), 3(2), 107-120, various methods of noble metal analysis are compared with one another with the aid of reference materials. It is found here that the recovery of the analytes by means of aqua regia extraction is low and varies greatly among the various matrices. Prior roasting has different effects: the recovery of platinum is not more than 75% of the actual value.

A disadvantage of fire assay is that methods based on it are relatively time-consuming. Typical working times for the analysis carried out manually are about one week. (M. Rehkamper, A. N. Haliday: Talanta 44 (1997) 663-672). The productivity (number of samples which can be analyzed per employee and working day) is therefore low.

Intensive tying-up of personnel, use of special analytical equipment and a high energy requirement lead to the costs of analysis by means of fire assay being high.

In some variants of fire assay (including when Ni is used as collector), the detection limits which can be achieved in practice are determined by blank analysis carried out on the reagents used and losses or memory effects of the container materials.

In addition, the composition of the complex mixtures of fusion agents and fluxes have to be matched precisely to the respective individual sample. This know-how is described, for example, in DE 112006002407T5.

The use of toxic materials requires particular safety measures for the analytical personnel in order to be able to adhere to the relevant MWC values. In addition, measures for protecting the environment have to be undertaken due to the vaporization and/or other disposal of the toxic materials.

Methods other than fire assay do not give a quantitative determination of the noble metals to be analyzed.

### SUMMARY

One aspect of the invention relates to a method of assaying noble metals in a mineral and/or ceramic matrix in the content range from 0.03 to 500 mg/kg. The method comprises dry thermal treatment of a homogenized sample in a reducing atmosphere, extraction in an oxidizing medium, and atomic spectrometric quantification of the noble metals by using inductively coupled plasma mess spectroscopy (ICP-MS). In some embodiments, the noble metals comprise platinum metals. According to other embodiments, the noble metals may comprise platinum, palladium, rhodium and/or iridium. In alternative embodiments, the noble metal comprises rhenium or comprises gold.

According to other embodiments, dry thermal treatment is carried out at a temperature have ranges of 400 to 1900 ° C. or 700 to 900 ° C. The reducing atmosphere during dry thermal treatment may comprise hydrogen gas.

Other embodiments are related to extraction. In certain embodiments, the oxidizing medium generates chlorine. In other embodiments, the oxidizing medium comprises hydrochloric acid and nitric acid. In a particular embodiment, the hydrochloric acid and nitric acid are present in a volume ratio of 3:1.

In yet other embodiments, extraction comprises movement of the sample. In other embodiments, extraction comprises no movement of the sample followed by movement of the sample. In yet other embodiments, extraction has a duration of from 10 minutes to 10 hours. In a more particular embodiment, extraction has a duration of from 2 to 8 hours, or in an even more particular embodiment, 3 to 6 hours.

In other embodiments, extraction may be carried out a temperature above room temperature. In certain embodiments, extraction may be carried out at a temperature above room temperature for a duration of 1 to 60 minutes. In a particular embodiment extraction comprises maintaining the homogenized sample without movement for a duration of 4 hours, shaking the homogenized sample at 60° C., shaking the homogenized sample at 80° C., shaking the homogenized sample at 100° C., and shaking the homogenized sample at 180° C.

Another aspect of the invention relates to a method of assaying noble metals in a mineral and/or ceramic matrix in the content range from 0.03 to 500 mg/kg. The method comprises homogenization of a sample comprising noble metals, dry thermal treatment of the homogenized sample in a the presence of hydrogen gas, extraction in an oxidizing medium comprising hydrochloric acid and nitric acid, wherein extraction comprises first holding the sample and then comprises shaking the sample, and atomic spectrometric quantification of the noble metals by means of ICP-QMS.

### DETAILED DESCRIPTION

In accordance with various embodiments of the invention, provided are methods of assaying noble metals in a mineral and/or ceramic matrix in the content range from 0.03 to 500 mg/kg. One aspect of the invention relates to such a method, which comprises the following steps:
(a) Dry thermal treatment of a homogenized sample in a reducing atmosphere;
(b) Extraction in an oxidizing medium;
(c) Atomic spectrometric quantification of the metals by means of ICP-QMS.

For the purposes of the present patent application, combinations of preferred embodiments should also always be considered to be disclosed according to various embodiments of the invention.

For the purposes of the present invention, an assay is the determination of the total content of a particular noble metal in all states. States are, for example, include:
metallic (native);
alloyed with other metals (solid solutions);
present as chemical compound with other elements and/or
present in charged (ionized) form, e.g. as salt.

For the purposes of the present patent application, the term “noble metal” comprises silver (Ag), gold (Au) and/or the platinum metals ruthenium (Ru), rhodium (Rh), palladium (Pd), iridium (Ir) and/or platinum (Pt). For the purposes of the present patent application, the term “platinum metal” comprises ruthenium (Ru), rhodium (Rh), palladium (Pd), iridium (Ir) and/or platinum (Pt). Furthermore, rhenium (Re) is considered to be a noble metal for the purposes of the present patent application. According to specific embodiments of the present invention, the methods provided herein may be used with noble metals that comprise platinum, palladium, rhodium and/or iridium. In further specific embodiments, the noble metal comprises rhenium. In other embodiments, the noble metal comprises gold.

The method of the invention can be used for the single determination of a particular noble metal. Furthermore, the method of the invention can be used for the simultaneous determination of two or more noble metals (multiple determination).

The noble metals are, according to various embodiments of the invention, the analyte (in the case of a single determination) or the analytes (in the case of a multiple determination), i.e. their content is to be determined.

The term matrix refers to the constituents of a sample which are not to be analyzed.

A mineral matrix is a matrix which is made up entirely or predominantly of one or more minerals. Minerals are naturally occurring solids having a defined chemical composition and a particular physical crystal structure.

An ore is a mineral mixture which is mined because of its metal content. It comprises metal-comprising ore minerals and the gangue which does not comprise metal.

A ceramic matrix is a matrix which is made up entirely or predominantly of one or more ceramics. Ceramics are articles which have been molded substantially from finely particulate raw materials with addition of water at room temperature and then dried and, in a subsequent firing process, sintered at above 900° C. to give harder, durable articles.

The raw materials can be inorganic. These include, for example, aluminum silicates such as clays and aluminosilicates such as kaolins. As particular raw materials, oxidic raw materials such as aluminum oxide and beryllium oxide are known. Nontoxic raw materials such as silicon carbide, boron nitride and boron carbide are used for producing nonoxidic ceramics.

Engineering ceramics are ceramic materials whose properties have been optimized for engineering applications. They are inorganic, nonmetallic and polycrystalline. In general, they are molded at room temperature from a raw composition formed by ceramic powder, organic binder and liquid and acquire their typical materials properties only in a sintering process at high temperatures.

Ceramics are often used as supports in exhaust gas catalysts.

In an embodiment of the invention, the method of the invention is used for determining noble metal in exhaust gas catalysts. Preferred noble metals here are Rh, Pd and/or Pt.

The exhaust gas catalysts can be fresh exhaust gas catalysts. In this case, the method of the invention can be employed for determining successful application of the noble metal in production.

The exhaust gas catalysts can also be used exhaust gas catalysts. In this case, the method of the invention can be employed for determining the loss of noble metal or for determining the remaining noble metal.

According to various embodiments of the invention, the content range of the noble metal to be determined or the noble metals to be determined is from 0.03 to 500 mg/kg. The content range of the noble metal to be determined or the noble metals to be determined is preferably from 0.03 to 50 mg/kg.

The sample to be analyzed is very often present in macroscopic form and in order to be analyzed at all has to be converted into a suitable form. This is achieved, according to various embodiments of the invention, by homogenization. For this purpose, nonseparating or nondiscriminating methods are employed. The method used is preferably milling.

A preferred way of effecting homogenization is to subject the sample to wet milling. For example, 100 g of sample, 575 g of ZrO₂ spheres (Ø=1.7−2.3 mm) and 100 g of water are milled together in a ball mill for a time of 15 minutes. After milling, the sample is freed of the spheres by sieving and dried to constant weight under reduced pressure at a temperature of 110° C. for a time of at least 12 hours. After drying, the sample is again crushed by means of a manual mortar.

According to various embodiments of the invention, the average particle size of the homogenized sample is not more than 100 μm, preferably not more than 50 μm. Preference is given to 95% of the particles being smaller than 70 μm. More preferably, 97% of the particles are smaller than 75 μm.

For the purposes of the present application, the average particle size is the value obtained by measurement by means of laser light scattering of an aqueous suspension of the particles to be examined. Suitable measuring instruments are, for example, those from the Malvern company, e.g. Malvern Mastersizer 2000, or from Sympatec.

To produce the aqueous suspension, a dilute sodium pyrophosphate solution can be used as dispersion medium. It is advantageous to predisperse the suspension by means of ultrasound in the measurement vessel before measurement, preferably at an ultrasound intensity in the measurement vessel of 100% before and during measurement.

A person skilled in the art will know that, owing to inhomogeneities, (e.g. nugget effect) in rock samples, up to 10-20 g of material should be analyzed in order to obtain a representative result (thesis by M. Müller, Universitat Mainz, 2001, page 119).

For this reason, the method of the invention is, particularly in the case of samples which are known to be inhomogeneous, carried out a plurality of times in order to obtain a representative result from the mean.

The dry thermal treatment is also referred to as roasted.

For the purposes of the invention, dry thermal treatment means that the samples have a liquid content of 5% by weight or less immediately before or during roasting.

One or more reducing agents are introduced during the dry thermal treatment. As reducing agent, preference is given to using hydrogen gas or mixtures comprising hydrogen gas.

The reducing agent can be introduced continuously, semicontinuously or batchwise. The reducing agent is preferably introduced continuously. The flow is set so that not more than 1500 ml of H₂ per g of sample and hour are supplied to the sample. Preference is given to supplying the sample with 500-1000 ml of H₂ per g of sample and hour.

The dry thermal treatment is carried out at a temperature of from 400 to 1200° C. preferably from 600 to 1000° C., particularly preferably from 700 to 900° C. A very particularly preferred embodiment is thermal treatment at a temperature of 800° C.

The dry thermal treatment is carried out for a time of from 0.5 to 10 hours, preferably from one to four hours, particularly preferably from 1.5 to three hours. In a very particularly preferred embodiment, the dry thermal treatment is carried out for a time of two hours.

To heat the sample for the desired time at the desired temperature, it is advantageously transferred into a space which is suitable for this purpose. Hereinafter, such a space will be referred to as a furnace.

Furnaces suitable for the purposes of the invention are, for example, smelting furnaces, heat treatment furnaces, tube furnaces, chamber furnaces, muffle furnaces, air convection furnaces, vacuum furnaces, rotary tube furnaces or convection drying ovens. A preferred furnace is a tube furnace.

The extraction takes place in an oxidizing medium.

Particular preference is given to media in which chlorine is generated in statu nascendi.

According to various embodiments of the invention, preference is given to mixtures of hydrochloric acid and nitric acid, preferably a mixture of hydrochloric acid and nitric acid in a volume ratio of 3:1, which is also known to those skilled in the art as aqua regia.

Preference is also given, according to various embodiments of the invention, to mixtures of hydrochloric acid and hydrogen peroxide.

According to various embodiments of the invention, the extraction takes place at a temperature of from 20° C. to 200° C. The extraction preferably commences at a low temperature, e.g. room temperature, and the temperature is increased in steps.

The extraction can take place with or without movement of the sample. Preference is given to the extraction beginning without movement of the sample and ending with movement of the sample.

The duration of the extraction is from 10 minutes to 10 hours. The duration of the extraction at room temperature is preferably from one to 10 hours, preferably from two to eight hours, very particularly preferably from three to six hours. The duration of the extraction at elevated temperature, i.e. at a temperature above room temperature, is preferably from one to 60 minutes, preferably from five to 30 minutes, very particularly preferably from 10 to 20 minutes.

In a particularly preferred embodiment, the extraction begins at a hold time of 4 hours at room temperature, such that the mixture is maintained without movement. Then, extraction is continued with the following heating profile, with frequent shaking:
15 minutes at 60° C.,
15 minutes at 80° C.,
15 minutes at 100° C.
15 minutes at 180° C.

After the samples have been extracted, the noble metals are determined quantitatively by means of an atomic spectrometric analysis method. According to various embodiments of the invention, the determination of the noble metals is carried out by means of ICP-MS (inductively coupled plasma mass spectrometry). This method is, for example, described in “Inorganic Mass Spectrometry, Principles and Applications” J. S. Becker, WILEY, 2007, ISBN 978-04-0470-01200-0; Houk, R. S., Fassel, V. A., Flesch, G. D., Svec, H. J., Gray, A. L. and Taylor, C. E., 1980. Inductively coupled argon plasma as an ion source for mass spectrometric determination of trace elements. Analytical Chemistry 52, 2283-2289; U.S. Pat. No. 5,218,204 and U.S. Pat. No. 6,265,717 B1. These documents are fully incorporated by reference.

A measurement system suitable for this task comprises the following basic components:
Sample introduction system (flow injection sample introduction system), atomizer, spray chamber) for measuring liquid samples by means of internal standardization
ICP flame as ion source for an argon plasma generated by high frequency induction
Interface which connects the plasma operating under atmospheric pressure to the mass spectrometer which is under a high vacuum
Lens system for focusing/guiding the ions into a reaction/collision cell; spectral interferences are minimized by using user-defined gases in the cell
Quadrupole mass filter
Detection unit
Vacuum system for interface, ion optics, quadrupole and detector
Data processing and evaluation unit

The measurement system has to be stable against matrix influences on the samples, i.e. the system stability has to be ensured or changes in the signal intensity have to be compensated via internal standardization. Possible systematic errors due to matrix-based mass-spectroscopic superimpositions make an effective method for minimizing interference necessary, e.g. in the form of a collision/reaction cell in the ICP-QMS. Solutions to these problems are known to those skilled in the art.

The following examples illustrate the invention without restricting it in any way.

### EXAMPLES

For all the steps carried out below, the acids, water and the gases used have to be sufficiently free of the elements to be determined. The same applies to the apparatuses used.

Homogenization

As sample material, use was made of a “Merensky Reef ore” which is commercially available under the name SARM 76 from MIKTEK (South Africa). This material is milled, i.e. homo-genized within the meaning of the present application, and has an average particle size of 70 μm, determined by laser light scattering using an instrument from Sympatec with the evaluation software WINDOX. Further homogenization was not carried out.

Step (a): dry thermal treatment (roasting)

Apparatus:

Small fused silica boats L×W×H in mm about 40×13×11 (external dimensions)

Large fused silica boat L×W×H in mm about 140×23×17 (external dimensions with eyelet)

Metal rod, with marking, for introducing the large fused silica boat

Fused silica tube with spherical ground joint and NS 29/32 female ground joint

Tube furnace Carbolite model STF 15/---/180

Reagents:

Hydrogen: purity at least 99.999% by volume

Nitrogen: purity at least 99.999% by volume

Shielding gas: shielding gas 5, from Praxair

A maximum of 7.5 g (+/±0.1 g) of the sample were weighed to within 0.1 mg into a fused silica boat. A Mettler AT 250 analytical balance was used for this purpose. The boat was positioned in the middle of the large fused silica boat.

During heating of the tube furnace to the final temperature, the tube furnace was flushed with nitrogen, flow about 4 standard 1/h. After the indicator on the furnace showed 800° C., the charged fused silica boat was pushed into the middle of the tube furnace.

After a “flushing time” of at least 10 minutes, the gas was changed over from nitrogen to hydrogen or a hydrogen-comprising gas mixture and the nitrogen was shut off. The flow rate of the hydrogen or hydrogen-comprising gas mixture was recorded.

The sample was then reduced for 2 hours at the final temperature under hydrogen or a hydrogen-comprising gas mixture. The gas was finally changed over to nitrogen again (flow rate about 4 standard 1/h) and the introduction of hydrogen or hydrogen-comprising gas mixture was stopped.

After a further “flushing time” of 10 minutes, the fused silica boat was pulled into the “cold zone” of the fused silica tube. After cooling, the sample was reweighed. The loss on ignition was calculated via the difference from the initial weight.

The respective final temperature, hydrogen or hydrogen-comprising gas and flow of the hydrogen or hydrogen-comprising gas are shown in table 1.

Step (b): Extraction in an oxidizing medium

The sample from step (a) was weighed into a 100 ml volumetric flask and admixed with 20 ml of aqua regia. “Aqua regia” is a freshly prepared mixture of hydrochloric acid (density about 1.18 g/ml) and nitric acid (density about 1.41 g/ml) in a volume ratio of 3:1.

This was followed by allowing to stand at room temperature for 4 hours.

The sample was treated on a hotplate according to the following heating profile, with frequent shaking:
15 minutes at 60° C.,
15 minutes at 80° C.,
15 minutes at 100° C.
15 minutes at 180° C.

After cooling to room temperature, the volumetric flask was made up to the mark with deionized water. The clear supernatant solution was diluted one to ten with simultaneous addition of an internal standard. As internal standard, a mixture of indium, holmium and thallium in a concentration of 10 μg/l based on the solution to be measured was added. This solution was analyzed.

A blank was carried out as per this description.

Step (c): Atomic spectrometric quantification of the noble metals by means of ICP-QMS

The analysis was carried out using an Agilent 7700x ICP-MS instrument equipped with integrated sample introduction system (ISIS) and high matrix interface (HMI).

The operating conditions relevant for carrying out the analyses were as follows:

Acid concentration matched to the samples

Measurement range 0.1-30 μg/l

Calibration 2/10/30 μg/l

Nebulizer pump: 0.08 rps

Atomizer: Meinhard; spray chamber: Scott-type; temperature of spray chamber: 2° C.

Gas settings: carrier gas: 0.7 l/min; plasma gas: 0.9 l/min: cooling gas: 15 l/min;

dilution gas: 0.44 l/min; cell gas: helium 4.4 ml/min; reaction mode: ON

Plasma conditions: RF power: 1550 W; RF matching: 2.1 V; sample depth: 8 mm;

torch-H: 0 mm; torch-V: 0.2 mm

Ion lenses: extract 1: 0 V; extract 2: −195 V; omega bias: −110 V; omega lens: 8.2 V; cell entrance: −40 V; cell exit: −60 V; deflect: −0.6 V; plate bias: −60 V

Octopole parameters: OctP RF: 170 V; OctP bias: −18 V

Q-pole parameters: AMU gain: 122 V; AMU offset: 127 V; axis gain: 0.9992; axis offset: 0.06; QP bias: −15 V

Detector parameters: discriminator 4.5 mV; analogue HV: 1699 V; pulse HV: 933V

TABLE 1
Experimental results on the assay of SARM 76

| | | Comparative | | Comparative | | | | | | | | | | | | | |
|---|---|---|---|---|---|---|---|---|---|---|---|---|---|---|---|---|---|
| | | experiment 1 | | experiment 2 | | | | | | | | | | | | | |
| | Certified | (without | | (without | | | | | | | | | | | | | |
| | value | roasting | | reducing | | Experiment | | Experiment | | Experiment | | Experiment | | Experiment | | | |
| | (fire assay) | operation) | | agent) | | 1 | | 2 | | 3 | | 4 | | 5 | | Blank SiO₂ | |
| Final | n.f. | n.f. | | 800° C. | | 800° C. | | 800° C. | | 800° C. | | 600° C. | | 800° C. | | 800° C. | |
| tem- | | | | | | | | | | | | | | | | | |
| pera- | | | | | | | | | | | | | | | | | |
| ture | | | | | | | | | | | | | | | | | |
| Gas | n.f. | n.f. | | N₂ | | H₂ | | H₂ | | H₂ | | H₂ | | shielding gas | | H₂ | |
| Flow | n.f. | n.f. | | 4 l/h | | 1.6 l/h | | 4 l/h | | 10 l/h | | 4 l/h | | 4 l/h | | 4 l/h | |
| | mg/kg | mg/kg | RSD | mg/kg | RSD | mg/kg | RSD | mg/kg | RSD | mg/kg | RSD | mg/kg | RSD | mg/kg | RSD | mg/kg | RSD |
| Pd | 1.50-1.57 | 1.05 | 1.41 | 1.18 | 8.27 | 1.39 | 7.52 | 1.37 | 5.32 | 1.38 | 4.29 | 1.36 | 3.15 | 1.39 | 3.22 | 0.00 | 108.11 |
| Pt | 3.50-3.68 | 0.90 | 4.95 | 3.23 | 8.56 | 3.81 | 5.02 | 3.64 | 9.89 | 3.80 | 4.79 | 3.53 | 8.23 | 3.65 | 4.70 | 0.02 | 41.25 |
| Rh | 0.248-0.264 | 0.22 | 1.76 | 0.19 | 3.64 | 0.22 | 3.67 | 0.22 | 9.73 | 0.22 | 4.89 | 0.22 | 1.75 | 0.16 | 3.44 | 0.00 | 64.41 |
| Au | 0.22-0.25 | 0.26 | 62.45 | 0.18 | 2.99 | 0.24 | 11.28 | 0.21 | 13.37 | 0.57 | 124.73 | 0.21 | 31.79 | 0.21 | 7.92 | 0.00 | 764.81 |

n.f.: No figure given/not applicable
RSD: Relative standard deviation of the individual results (in %; n = 6, i.e. each measurement was carried out six times)

1. A method of assaying noble metals in a mineral and/or ceramic matrix in the content range from 0.03 to 500 mg/kg, the method comprising:
dry thermal treatment of a homogenized sample in a reducing atmosphere;
extraction in an oxidizing medium; and
atomic spectrometric quantification of the noble metals using ICP-QMS.

2. The method according to claim 1, wherein the noble metals comprise platinum metals.

3. The method according to claim 2, wherein the noble metals comprise platinum, palladium, rhodium and/or iridium.

4. The method according to claim 1, wherein the noble metal comprises rhenium.

5. The method according to claim 1, wherein the noble metal comprises gold.

6. The method of claim 1, wherein dry thermal treatment is carried out at a temperature having a range of about 400 to 1200° C.

7. The method of claim 6, wherein dry thermal treatment is carried out at a temperature having a range of about 700 to 900° C.

8. The method of claim 7, wherein the reducing atmosphere comprises hydrogen gas.

9. The method of claim 1, wherein extraction comprises movement of the sample.

10. The method of claim 9, wherein extraction comprises no movement of the sample and then movement of the sample.

11. The method of claim 1, wherein extraction has a duration of from 10 minutes to 10 hours.

12. The method of claim 11, wherein extraction has a duration of from 2 to 8 hours.

13. The method of claim 12, wherein extraction has a duration of from 3 to 6 hours.

14. The method of claim 1, wherein extraction is carried out at a temperature above room temperature.

15. The method of claim 14, wherein extraction is carried out at a temperature above room temperature for a duration of 1 to 60 minutes.

16. The method of claim 1, wherein extraction comprises
maintaining the homogenized sample without movement for a duration of 4 hours at room temperature;
shaking the homogenized sample at 60° C.;
shaking the homogenized sample at 80° C.;
shaking the homogenized sample at 100° C.; and
shaking the homogenized sample at 180° C.

17. The method of claim 1, wherein the oxidizing medium generates chlorine.

18. The method of claim 17, wherein the oxidizing medium comprises hydrochloric acid and nitric acid.

19. The method of claim 18, wherein the hydrochloric acid and nitric acid are present in a volume ratio of 3:1.

20. A method of assaying noble metals in a mineral and/or ceramic matrix in the content range from 0.03 to 500 mg/kg, the method comprising:
homogenization of a sample comprising noble metals;
dry thermal treatment of the homogenized sample in a the presence of hydrogen gas;
extraction in an oxidizing medium comprising hydrochloric acid and nitric acid, wherein extraction comprises first holding the sample and then comprises shaking the sample; and
atomic spectrometric quantification of the noble metals using ICP-QMS.
